(19) United States
(12) Patent Application Publication
(10) Pub. No.: US 2003/0147420 A1
(43) Pub. Date: Aug. 7, 2003

(54) Wireless communications hub with protocol conversion

(76) Inventor: Robert W. Beckwith, Clearwater, FL (US)

Correspondence Address: R. W. Beckwith, 2794 Camden Road, Clearwater, FL, 33759, US

(21) Appl. No.: 10/405,558

(22) Filed: Apr. 2, 2003

Related U.S. Application Data
(63) Continuation-in-part of application No. 10/074,110, filed on Feb. 11, 2002, now abandoned.
Application No. 10/074,110 is a continuation-in-part of application No. 09/479,650, filed on Jan. 8, 2000.
(60) Provisional application No. 60/116,984, filed on Jan. 25, 1999.

(51) Int. Cl. H04Q 7/24; H04L 12/56

(52) U.S. Cl. 370/466; 370/400; 370/338

(57) ABSTRACT

A wireless hub uses a first processor to communicate with IEDs, uses a second processor to communicate with landline SCADA, and uses a third processor to extract, store and exchange messages between SCADA protocols and IED protocols so as to as to permit two way communications between SCADA devices and IED which are independent of protocol and time of exchange.

This application is a continuation in part of application Ser. No. 10/074,110 titled A WIRELESS COMMUNICATIONS HUB WITH PROTOCOL CONVERSION filed for Robert W. Beckwith on Feb. 11, 2002 which was a continuation in part of application Ser. No. 09/479,650 titled “EXPANDED CAPABILITIES FOR WIRELESS TWO-WAY PACKET COMMUNICATIONS FOR IEDs” filed by Robert W. Beckwith on Jan. 8, 2000 which claimed the priority date of provisional patent application Serial No. 60/116,984 filed by Robert W. Beckwith on Jan. 25, 1999 titled “RADIO AS THE MAN/MACHINE INTERFACE FOR AN IED”.

### REFERENCES

A. U.S. patent application Ser. No. 10/246,941 “WIRELESS TRANSCEIVERS USING A SIMPLIFIED PRISM II SYSTEM” filed by Robert W. Beckwith, the inventer herein, on Sep. 19, 2002.

B. The IEEE 100 dictionary of IEEE standards terms, seventh edition defines the following terms which are used herein:

1. “intelligent electronic device (IED) Any device incorporating one or more processors with the capability to receive or send data/control from or to an external source.”

2. “supervisory control (1) (supervisory control, data acquisition, and automatic control) An arrangement for operator control and supervision of remotely located apparatus using multiplexing techniques over a relatively small number of interconnecting channels.

A form of remote control of remotely located units by electrical means over one or more common interconnecting channels.”

C. Motorola MC9S12A256 Device Guide V01.01 as revised Apr. 12, 2002.

### SUMMARY OF THE INVENTION

In the present invention a hub uses a wireless transceiver to communicate with IEDs. Both the hub and the IEDs use Beckwith Electric BLUEJAY™ wireless devices, which use selected Intersil Prism II chips, for communications as peers with each other. The BLUEJAY™ wireless transceivers do not attempt to avoid data crashes and use the inherent capability of selected Intersil Prism II wireless chips to avoid data crashes and other modes of communications failure. Each BLUEJAY™ device on an IED is given one of 255 addresses supporting communications between any two at a time with one address reserved for the hub. Groups of IEDs may be given additional of the 255 addresses and communicated with by groups from the hub.

A P protocol processor in the hub exchanges two way digital messages with IEDs, and passes the messages to a D data processor. An S processor communicates to SCADA systems and passes two way SCADA messages to the D processor. The D processor holds instructions to permit exchange of messages with any substation IEDs in spite of protocol differences amongst the IEDS. The D processor stores messages in generic format and when requested converts it to a single protocol format of choice for two way communications with an external SCADA system using the chosen protocol. The D processor stores data for any required length of time serving as a message and protocol buffer between land based SCADA communications and IEDs.

### BRIEF DESCRIPTION OF THE DRAWINGS

FIG. 1 A block diagram of the wireless communications hub communicating with two IEDs.

FIG. 2 The connections of a user interface computer to the hub.

FIG. 3 Details of hub connections to SCADA lines.

### DETAILED DESCRIPTION OF THE PREFERRED EMBODIMENTS

The term “SCADA” (for Supervisory Control And Data Acquisition) is used herein to refer to practice as described in reference B.

The term “protocol” is used herein to include both the format of data communications and also the list of data points and other IED device specific messages. This list not only changes between suppliers of IEDs but with changes each supplier makes over the course of time and the requirements of the user when placing an order. Some details of the messages may consist of user setpoints subject to change by the user.

In other words, the protocol of a message is simply the rules for converting a message string of ones and zeros to information in the message such as Volts, Amps, Watts and VArs.

The term “bit-stream” is used herein to indicate a combination of message and serial digital bits added for routing messages flowing in either direction between a first location and a second location. A message is the useful content of a bit-stream. Any digital message consists of a sequence of one or more packets which are specific for any application. The packet length in bits is generally given in a header for any bit-stream.

Any digital message consists of a sequence of one or more packets. The transmission rate for a message is a function of the time between packets. The inter-packet time, and therefore the message rate may vary dependent on the media carrying the message. The word “packet” as used herein refers exclusively to such serial packets of bits within messages.

The Prism II chip set sends each packet a number of times. For example, a first originating station listens before sending a packet. If a signal is received, transmission by the first station is delayed a random amount of time. Any second station that might have originated a transmission, but also receives a signal, also waits a random time certain to be different than that of the first station thus avoiding a data crash between the first and second station.

The above discussion of data crash avoidance is but one of a number of ways used by the Prism II base band processor to send a packet. Experience shows that there is a very high probability that packets will have been received by the intended receiver within one microsecond. One megabit per second was therefore chosen by experience for the bit-stream rate of the BLUEJAY™ products referred to herein.

The ratio of bits in a message to bits in a bit-stream is defined herein as the “wireless coding efficiency”. The efficiency of the BLUEJAY™ products is generally better than 50% depending on the application.

The hub of this invention communicates with Beckwith Electric Company (BECO) wireless devices from the BLUEJAY™ BECO product line. As described in U.S. patent application Ser. No. 10/246,941, Reference A, devices in the BLUEJAY™ product line communicate with each other using steering codes generally eight bits in length. Each IED device has a first eight bit identity code with additional eight bit codes that can be assigned by groups of IED to permit the hub to communicate globally with each such group of IEDs. Each group is identified by one of the additional codes. The BLUEJAY™ devices communicate at a bit-stream rate of one million bits per second with further programmed retries for errors detected by error detection coding.

BLUEJAY™ devices are applied in ways that minimize unnecessary wireless transmissions. IEDs are capable of initiating a message as conditions require. Scanning of IEDs by the hub is discouraged in order to avoid swamping the capability of selected Intersil Prism II chips to avoid data crashes.

All references to the BLUEJAY™ products are given for the purpose of understanding communications between the hub of this invention and BLUEJAY™ products. BLUEJAY™ products are covered by other patent applications in progress and no claims are made herein to extend or modify these applications in progress.

The wireless communications hub of this invention uses three processors, each having non-volatile memory with programs contained therein to permit independent operation of the three processors working together synchronously as required for overall operation of the hub. These three processors are preferably Motorola MC9S12A256 Type 112 LQFP devices as described in Reference C above.

This overall operation provides bidirectional communication paths between land line SCADA devices using protocols of choice and IEDs also using protocols of independent choice. Variable time delays are provided for these bidirectional communication paths as suitable for practical applications of the hub.

Parallel transfer of data between processors can be programmed to fall within the time of a single task of a multitask program and in some operations even within the time of one bit of data.

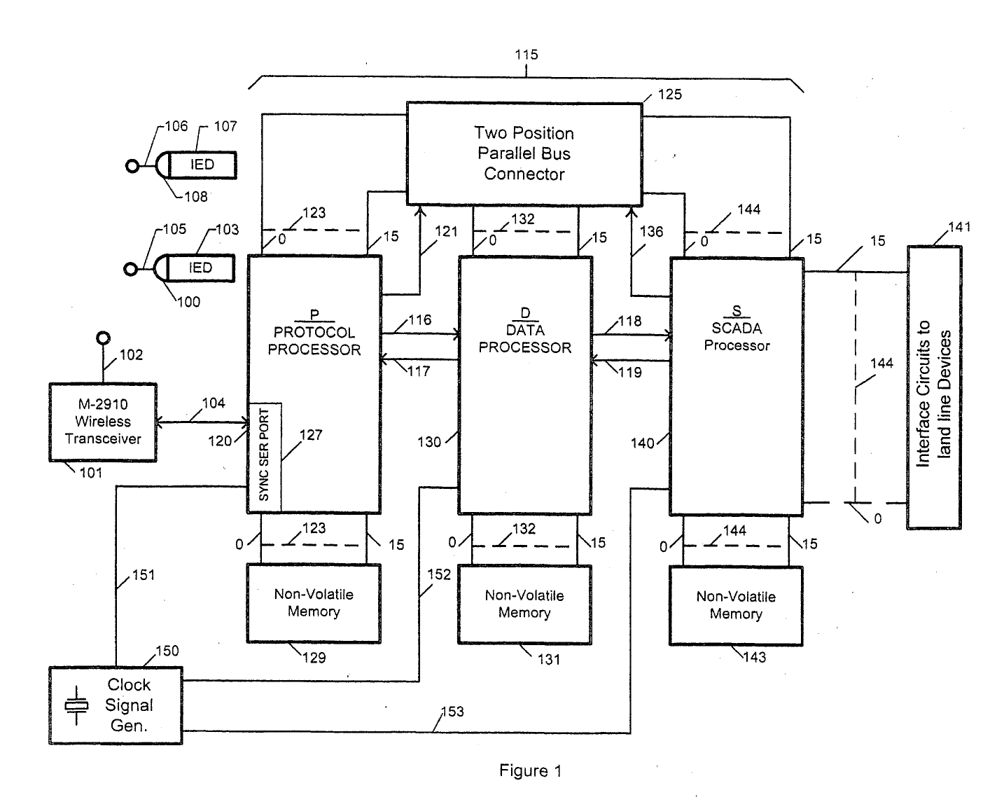

FIG. 1 shows the communications hub 115 as an interface device between land line devices and IEDS. The hub 115 uses wireless transceivers 101 each having an antenna 102. Presently transceiver 101 is an M-2910 BLUEJAY™ device as manufactured by the Beckwith Electric Co. Inc. The M-2910 101 device uses an 8 bit code to communicate with up to 255 IEDs (103) so as to provide a brief wireless connection between the hub 115 and IEDs which is transparent to the protocol of each IED. IEDs 103 and 107 are typical of two of the possible 255 IEDs which may be used in a typical application of the present invention. Wireless adapters 100 with antenna 105 and 108 with antenna 106 illustrate BLUEJAY™ devices which may be used with IEDs 103 and 107. Choice of the particular BLUEJAY™ device is dependent on requirements of each IED.

In some commercial applications wireless transceivers 100 and 108 are Beckwith Electric M-2911 Wireless-to RS232/422/485 Modules connected to via an RS232, RS422, or RS485 port depending on which port is provided on any particular IED.

In other applications the IEDs may use self contained M-2910 101 wireless transceivers having antennae 102 for communicating with the M-2910 101 wireless transceiver serving the hub 115.

Digital data is generally transmitted in streams of packets at a first data rate as determined by the application of the BLUEJAY™ devices. These packets are combined to make up a second real time communications bit-stream rate. One megabit per second is the bit-stream rate of choice for all BLUEJAY™ devices.

Common clock signal generator 150 supplies the clock signal over connection 151 for the P processor 120, over connection 152 to the D processor 130 and over connection 153 to the S processor 140. This permits two way parallel synchronous transfer of data between P and D and between S and D processors.

Wireless transceiver 101 communicates with protocol processor P over bidirectional connection 104 to P processor 120 synchronous serial port 127 of non-volatile memory 129. Processor P 120 uses minimal data buffering and passes bit-streams at maximum bit rates of one megabit per second between various IEDs and the D processor 130. The D processor 130 extracts messages from said bit-streams, stores said messages and manages said files of IED data organized by the eight bit code assigned to each IED.

The D processor 130 stores IED data in generic format and from that converts to the format required by a protocol in use in the S processor 140. For example, the generic format of choice may be binary coded decimal or straight binary. The D processor 130 uses non-volatile memory registers 131 for storing said messages. In addition to the data itself, a program is included for each IED with specific information required to operate properly with each IED 103/107 including, as necessary numbers for scaling numerical messages and settings as established by the user.

The P processor 120 exchanges bit-streams in either direction with D processor 130 via two position parallel bus connector 125 by means of 16 parallel connections 0 through 15 labeled as a group 123. The S processor 140 exchanges bit-streams in either direction with D processor 130 via two position parallel bus connector 125 by means of 16 parallel connections 0 through 15 labeled as a group 144. Two position parallel bus connector 125 is switched as described hereinunder to connect 16 parallel connections 0 through 15 labeled as a group 123 to parallel connections 132 for communications between processor P 120 and processor D 130 when operation of the hub 115 requires communications between P and D. Two position parallel bus connector 125 connects 16 parallel connections 0 through 15 labeled as a group 144 to parallel connections 132 for communications between processor S 140 and processor D 130 when operation of the hub 115 requires communications between processors S and D.

The S processor 140 also exchanges bit-streams in either direction with selected land line SCADA devices via interface circuits 141 by means of parallel connections 0 through 15 labeled as a group 144. Note that for clarity of the drawing the group 144 shown at the top of processor S 140 and again at the right of processor 140 duplicate the group 144 at the bottom connected to non-volatile memory 133. These three directions of communications are time shared as tasks on a multitask program within S processor 140.

Use of connections 123 is time shared by multitask programming means within P processor 120 between management of non-volatile memory 129, communications with two position parallel bus connector 125 and communications with wireless transceiver 101. Use of connections 132 is time shared by multitask programming means within D processor 130 between management of non-volatile memory 131 and communications with two position parallel bus connector 125. Use of connections 144 is time shared by multitask programming means within S processor 140 between management of nonvolatile memory 143, communications with two position parallel bus connector 125 and communications with selected interface circuits 141.

Either the P or the S processor are connected by the two position parallel bus connector 125 to 16 parallel connections 0 through 15 of the D processor labeled as a group 132. Pairs of binary ports and terminals for parallel data transfer are set on each of the three processors when the processor chips are initialized in manufacture. One of each such pair is set to send and the second to receive a binary input. These binary ports are used to establish directional pairs of lines 116/117 and 118/119. To initiate communications from P processor 120 to D processor 130 a first directional binary line of pair 116 initiates communications from P to D which is acknowledged by a signal on the second line of pair 16 in the return direction from D to P. Likewise pair 117 are used to communicate from D to P, pair 118 to communicate from D to S and pair 119 to communicate from S to D. While any one pair of lines is acknowledged, communications is blocked by programming in the processors from being initiated by another pair. When processor P has been acknowledged to communicate in either direction with D, processor P sends a binary one on binary line 121 so as to switch two position parallel bus connector 125 for communications from P to D for the time duration of the bit stream being communicated. Similarly when processor S has been acknowledged to communicate in either direction with D, processor S sends a binary one on binary line 136 so as to switch two position parallel bus connector 125 for communications from S to D for the time duration of the bit stream being communicated. Note that a binary one is not possible at the same time on lines 121 and 136 since simultaneous communications from P to D and S to D is not permitted. When no communications is being processed, between P and D or between S and D, two position parallel bus connector 125 may remain connected in either direction.

Lines 0 through 15 on each of parallel busses 123, 132 and 144 represent the first and last of the 16 connectors on the parallel busses.

The bit-stream data rates provided by parallel transfers are high as compared to the one microsecond bit time of the standardized one megabit per second bitstream rate of BLUEJAY™ devices thus providing avoidance, on a bit by bit basis, of data crashes within the hub 115. Moreover, headers on bit-streams may be used to assure that an entire bitstream passes between processors without interruption. Even still further, the dwell time of a multitask program in multitask programs may be used to manage the avoidance of data crashes. Further details of programs used within the hub 115 are beyond the scope of the present invention.

The D processor 130 buffers data and converts protocol data as required by any application of Hub 115. At no time do the P 120 and S 140 processors communicate with each other.

The S processor 140 serves external sources through interface circuits to land line devices 141 by means of a selection of protocol programs loaded into non-volatile memory 133 such as:

a. ASCI

b. Cooper 2179

c. BECO 2179

d. BECO 2200

e. PG&E 2179

f. IEC 870.5

g. UCA 4.0

h. DNP 3.0

i. MODBUS/MODBUS Plus

j. Swedish ISO 61850

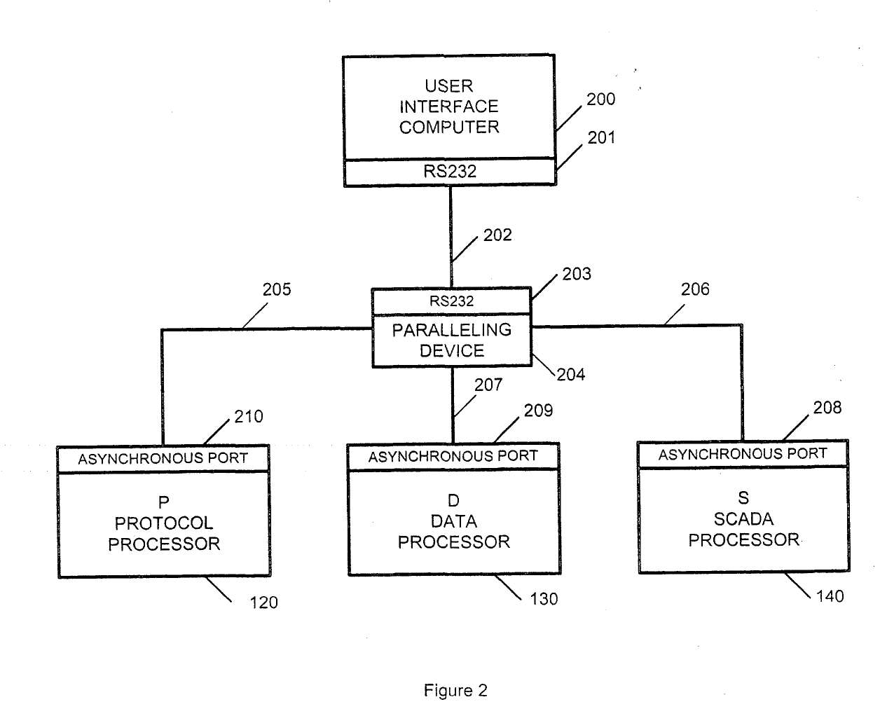

FIG. 2 shows a user interface computer 200 using a program known as “HUBCOM”. When needed, interface computer 200 can be interconnected with the hub 115 by use of cable 202. One end of cable 202 is inserted into RS232 port 201 on computer 200 with the other end connected to RS232 port 203 on RS232 paralleling device 204 located within Hub 115. The RS232 paralleling device 204 connects to asynchronous port 210 on P processor 120 via connection 205, to asynchronous port 209 on D processor 130 via connection 207 and to asynchronous port 208 on S processor 140 via connection 206.

The user will be required select the SCADA program protocol of choice as contained in non-volatile memory 143 of the S processor. Said HUBCOM program will then activate the S program of choice and instruct the D processor of this choice so as to make the proper protocol conversion from a selected IED to the SCADA program of choice.

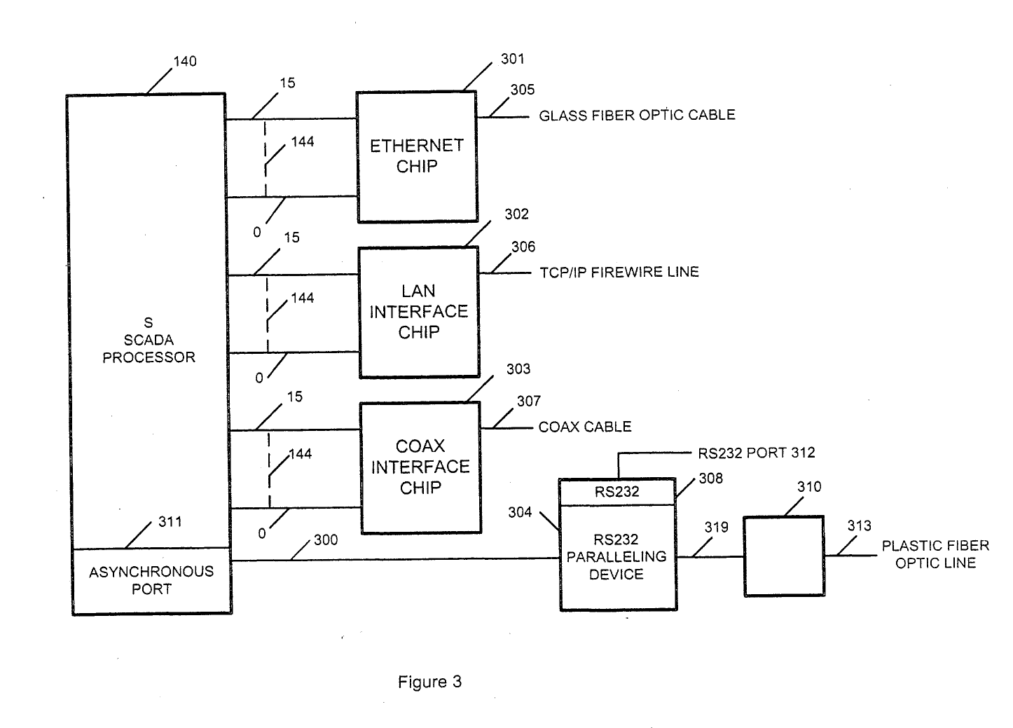

FIG. 3 describes connections from interface circuits 141 to land line devices 141 (as shown in FIG. 1) in greater detail.

The S processor is connected by 16 parallel connections 0 through 15 labeled as a group 144 to Ethernet SMS 91C111 LAN chip 301 serving glass fiber optic cable 305. One task of the multitask programming used in the S processor 140 time shares connections 144 with ethernet chip 301 to provide the highest speed possible in handling ethernet inputs.

TCPIP/Firewire data input 306 is connected to LAN interface chip 302. Another task of the multitask programming used in the S processor 140 time shares connections 144 connected to chip 302.

Coax cable input 307 is connected to coax interface chip 303. A further task of the multitask programming used in the S processor 140 time shares connections 144 connected to chip 303.

Asynchronous port 311 from S processor 140 is connected by connection 300 to RS 232 paralleling device 304. Plastic fiber optic line 313 connects to device 310. Device 310 converts from light signals on plastic fiber optic line 313 to electrical signals on connection 319 to RS232 paralleling device 304. RS232 port 312 on hub 115 connects to RS232 port 308 on RS232 paralleling device 304.

Preferably all external communications ports are available to the user at all times with user choices of ports established by program means within the S processor 140. With the user interface computer 200 in use, the HUBCOM program is then used by the user to set said choice of ports in said program means. The S processor 140 accomplishes this selection by enabling or disabling tasks of the multitask program used by S processor 140.

Said HUBCOM program provides password protection of said user choices of ports.

### ADVANTAGES OF THE INVENTION

A. Allows IED protocols to be different from each other and different than the protocol used by SCADA.

B. Takes the cost of ethernet protocol handling out of IEDs and places a single cost in the hub.

C. Allows the use of simple protocols in substation IEDs.

D. Provides easy updating of protocol programs as standards change.

E. Providing access to IED data not restricted by protocol standardization.

1. A communications hub as an interface device between land line devices and IEDs comprising in combination:
a) wireless transceiver means for exchanging digital bit-streams in either direction between said IEDs and said hub,
b) first processor means in said hub for exchanging bit-streams in either direction with said IEDs via said wireless transceivers,
c) second processor means in said hub for exchanging bit-streams in either direction with land line devices,
d) third processor means in said hub for communicating digitally with either said first processor or with said second processor,
e) third processor program means for exchanging bit-streams in either direction with said IEDs via said first processor,
f) third processor program means for exchanging bit-streams in either direction with said land line devices via said second processor,
g) program means in said third processor for extracting messages contained in said bit-streams and converting message protocols in either direction between that of IEDs and that of land line devices, and
h) storage means in said third processor for storing messages for a selected time before sending in either direction through said hub
whereby communications through said hub are not constrained by individual protocols or by time of transmission or reception.

2. A device as in claim 1 wherein said program means for said third processor converting said messages to a generic format for converting message protocols as they flow in either direction through said hub.

3. A device as in claim 1 wherein said third processor includes non-volatile memory.

4. A device as in claim 1 wherein said program means for said third processor uses the eight bit code assigned to each said IEDs as the identifier for non-volatile memory associated with each said IED.

5. A device as in claim 1 further comprising in combination:
a) non-volatile memory for use with said first processor,
b) synchronous serial port for said non-volatile memory,
c) connection means between said synchronous serial port and said wireless transceiver means for exchanging digital bit-streams in either direction between said IEDs and said hub, and
d) program means for said first processor means for exchanging digital bit streams in either direction between said IEDs and said first processor of said hub.

6. A device as in claim 1 further comprising in combination:
a) program means in said third processor for converting digital bit streams to protocols of said land line devices,
b) program means in said first processor for exchanging said bit streams with said second processor,
c) program means in said second processor for exchanging said bit streams with said third processor, and
d) program means in said second processor for exchanging said bit streams with said land line devices
whereby land line devices communicate with IEDs with translation in protocols in either direction from that of the IEDs and that of the land line devices and with selective time delays in communications.

7. A device as in claim 1 wherein a single device means provides clock signals to said first, second and third processors whereby said first, second and third processors operate in synchronism.

8. A device as in claim 1 further comprising in combination:
a) means for providing two position parallel bus connections,
b) means for connecting said first processor and a first input of said two position parallel bus connection,
c) means for connecting said second processor and a second input to said two position parallel bus connection,
d) means for connecting said third processor means and a common input to said two position parallel bus connection,
e) a binary control connection between said first processor and said two position parallel bus connection,
f) a binary control connection between said second processor and said two position parallel bus connection,
g) program means for each said first and second processors for switching the direction of said two position parallel bus connection, and
h) further program means for said third processor means choosing between communications with said first processor means and communications with said second processor means
whereby digital bit streams are exchanged at high speeds using parallel bus connections.

9. A device as in claim 1 wherein said first processor communicates wirelessly with IEDs using the protocol of each IED.

10. A device as in claim 1 wherein said second processor communicates with selected SCADA devices using the protocol of said selected SCADA device.

11. A device as in claim 1 wherein said third processor means stores messages, converts protocols and exchanges messages between IED devices and SCADA devices.

12. A device as in claim 1 further comprising in combination:
a) computer means for user communications with said hub,
b) RS232 port for said user interface computer means,
c) paralleling device means for paralleling RS232 ports,
d) RS232 port for said paralleling device,
e) means for connecting said paralleling device to an RS232 port for use with said user interface computer,
f) means for connecting between said paralleling device and asychronous ports of each of said first, second and third processors, and
g) program means for said user interface computer for entering required programs into each of said first, second and third processors.

13. Interface computer means as in claim 12 for entering SCADA protocol programs into said second processor
whereby the choice of SCADA protocol is independent of the protocol of any IED.

14. Interface computer means as in claim 12 for entering programs for operation of said communications hub into said first, second and third processors.

15. Interface computer means as in claim 12 whereby a user can enter data as required by any specific IED.

16. Interface computer means as in claim 12 whereby a user can read data related to any specific IED.

17. A communications hub comprising in combination:
a) a first microprocessor means for processing bit-streams in either direction using a plurality of first message protocols,
b) digital port means for said first microprocessor exchanging bit-streams in either direction with first outside sources,
c) a second microprocessor means for processing bit-streams in either direction using a plurality of second message protocols,
d) digital port means for said second microprocessor exchanging bit-streams in either direction with second outside sources,
e) a third microprocessor means for storing, converting message protocols and exchanging digital bit-streams in either direction with said first microprocessor for communications with said first outside sources, and
f) said third microprocessor also having means for storing, converting message protocols and exchanging digital bit-streams in either direction with said second microprocessor for communications with said second outside sources.

18. A method of providing communications between IEDs and land line devices, said method comprising the steps of:
a) providing a communications hub having multiple digital processors for processing bit-streams flowing between a land line device and addressed IEDs,
b) connecting bit-streams flowing between a first of said processors in the format of said IEDs,
c) connecting bit-streams flowing between a land line device and a second of said processors in the format of said device,
d) selectively switching between communicating between said first and a third of said processors and communicating between said second and said third processor,
e) in said third processor, converting messages in the protocol of said IEDs, as contained in bit-streams flowing between said IEDs and said hub, into a generic format,
f) in said third processor, converting messages in the protocol of said land line devices, as contained in bit-streams flowing between said land line devices and said hub, into a generic format,
g) in said third processor, using generic formats for converting messages in either direction between IED formats and land line device formats, and
h) storing said converted messages in said third processors for subsequent transmission,
whereby communications through said hub are not constrained by individual protocols or by time of transmission or reception.

19. A method as in claim 18 further including the steps of:
a) connecting an interface computer in parallel to asynchronous ports in each of said three processors, and
b) providing inputs through said interface computer to activate selected programs in said three processors, and to enter and receive selected data to and from said processors.

20. A method as in claim 18 including the following steps:
a) communicating between said first and third processors using bus to bus parallel transfer of data,
b) communicating between said second and third processors using bus to bus parallel transfer of data,
c) using first pairs of control lines definable as A and B for enabling communications between said first and third processors,
d) using second pairs of control lines definable as C and D for enabling communications between said second and third processors, and
e) selectively enabling only one of said pairs of control lines during a given time and inhibiting the other of said pairs whereby data crashes of data flowing in either of two directions through said hub are avoided.
